(19) United States
(12) Patent Application Publication
(10) Pub. No.: US 2022/0198751 A1
(43) Pub. Date: Jun. 23, 2022

(54) THREE-DIMENSIONAL-BODY DATA GENERATION DEVICE, THREE-DIMENSIONAL-BODY DATA GENERATION METHOD, PROGRAM, AND MODELING SYSTEM

(71) Applicant: MIMAKI ENGINEERING CO., LTD., Nagano (JP)

(72) Inventor: Kyohei Maruyama, Nagano (JP)

(73) Assignee: MIMAKI ENGINEERING CO., LTD., Nagano (JP)

(21) Appl. No.: 17/432,091

(22) PCT Filed: Mar. 11, 2020
(86) PCT No.: PCT/JP2020/010620

§ 371 Date: Aug. 19, 2021

(30) Foreign Application Priority Data
Mar. 15, 2019 (JP) 2019-048792

(51) Int. Cl. G06T 17/20; G06T 7/90; G06T 7/40; G06T 7/55

(52) U.S. Cl. CPC G06T 17/20; G06T 7/90; G06T 2200/08; G06T 7/55; G06T 7/40

(57) ABSTRACT

A three-dimensional-body data generation device is provided and generates three-dimensional shape data of a three-dimensional target object based on multiple images obtained by photographing the target object from mutually different viewpoints, which performs, using multiple images photographed in a state where a color sample is placed around the target object, a color sample search process of searching the color sample appearing in the image for at least any of the multiple images, a color correction process of performing color correction of the multiple images based on a color indicated in the image by the color sample discovered in the color sample search process, a shape data generation process of generating the three-dimensional shape data based on the multiple images, and a color data generation process of generating color data based on a color of the multiple images after correction is performed in the color correction process.

### TECHNICAL FIELD

This invention relates to a three-dimensional-body data generation device, a three-dimensional-body data generation method, a program, and a modeling system.

### BACKGROUND ART

Conventionally, a method of acquiring data indicating the shape of a three-dimensional object by using a 3D scanner or the like is known (for example, see Patent Literature 1). The 3D scanner estimates the shape of a three-dimensional object by, for example, a photogrammetry method of estimating a three-dimensional shape using camera images (two-dimensional images) photographed from a plurality of different viewpoints.

### CITATION LIST

### Patent Literature

Patent Literature 1: Japanese Unexamined Patent Publication No. 2018-36842

### SUMMARY OF INVENTION

### Technical Problems

In recent years, a 3D printer, which is a shaping device that shapes a three-dimensional shaped object, has become widespread. As an intended purpose of a 3D printer, shaping using data of the shape of a three-dimensional object read by a 3D scanner has been considered. In this case, shaping a shaped object colored in accordance with the color of the three-dimensional object to be read by the 3D scanner has also been considered.

For example, when a 3D scanner or the like is used in such an intended purpose, it is desired to appropriately acquire the color of the three-dimensional object with high accuracy. It is therefore an objective of this invention to provide a three-dimensional-body data generation device, a three-dimensional-body data generation method, a program, and a modeling system that can solve the above problems.

### Solutions to Problems

When an image (camera image) of a three-dimensional object is photographed by a 3D scanner or the like, a difference may occur between the color in the image and the original color of the three-dimensional object due to an influence of an environment such as illumination conditions. As a result, it sometimes becomes difficult to correctly recognize the color of the three-dimensional object.

On the other hand, the inventor of this application has conducted an intensive research on a method of reading the shape and color of a three-dimensional object with higher accuracy. The inventor of this application has found that, by using a plurality of images photographed in a state where a color sample such as a color target is placed around the three-dimensional object (target object) to be read, it is possible to appropriately read the shape and color of the three-dimensional object with high accuracy while automatically adjusting the color. Further intensive researches have made the inventor find features necessary for obtaining such effects, and achieve this invention.

In order to solve the above problems, this invention provides a three-dimensional-body data generation device that generates a three-dimensional shape data that is a data indicating a three-dimensional shape of a target object which is three-dimensional based on a plurality of images obtained by photographing the target object from mutually different viewpoints, the three-dimensional-body data generation device being configured to perform: using, as the plurality of images, a plurality of images photographed in a state where a color sample indicating a preset color is placed around the target object; a color sample search process of searching the color sample appearing in the image for at least any of the plurality of images; a color correction process of performing color correction of the plurality of images based on a color indicated in the image by the color sample discovered in the color sample search process; a shape data generation process of generating the three-dimensional shape data based on the plurality of images; and a color data generation process of generating a color data that is a data indicating a color of the target object, a process of generating the color data based on a color of the plurality of images after correction is performed in the color correction process.

This configuration enables color correction to be appropriately performed, for example, even when an image obtained by photographing a target object is out of color registration or the like. This enables, for example, the shape and color of the target object to be appropriately read with high accuracy.

Here, in this configuration, the target object is, for example, a three-dimensional object used as a target whose shape and color are to be read. As the color sample, for example, a color chart indicating a plurality of preset colors can be suitably used. As such a color chart, a commercially-available, known color target or the like can be suitably used.

In this configuration, the color data generation process is to generate color data in which, for example, the color of each position of the target object is indicated in association with the three-dimensional shape data. As the color data, for example, data indicating the color of the surface of the target object may be generated.

In the configuration, the color sample may be placed at a discretionary position around the target object. In this case, in the color sample search process, for example, the color sample is searched in a state where the position of the color sample in the image is unknown. This configuration enables a color sample to be placed at various positions, for example, in accordance with the shape of the target object. The color sample may be placed near a portion where color reproduction is particularly important.

When photographing a three-dimensional target object, the way the color is seen may vary depending on the position of the target object due to the influence of the way the target object is exposed to light. In this case, it is conceivable to use a plurality of images photographed, for example, in a state where a plurality of color samples placed around the target object. In this case, in the color correction process, the color correction of the plurality of images is performed, for example, based on the color indicated in the image by each of the plurality of color samples. This configuration enables, for example, color correction to be appropriately performed with higher accuracy.

This configuration may generate three-dimensional shape data using some feature points extracted from among a plurality of images, for example, in the shape data generation process. Such process may include adjusting the positional relationship between the plurality of images using a feature point, for example, when synthesizing images so as to connect a plurality of images. In this case, for example, at least a part of the color sample may be used as a feature point. More specifically, in this case, in the color sample search process, at least a part of the color sample appearing in the image is detected as a feature point. In the shape data generation process, the three-dimensional shape data is generated based on the plurality of images by using the feature point, for example. This configuration enables, for example, generation of three-dimensional shape data to be appropriately performed with higher accuracy.

In this case, it is preferable to use, as the color sample, a configuration having a discrimination part indicative of being a color sample, for example. For example, a member for a marker having a preset shape may be used as the discrimination part. In this case, in the color sample search process, for example, the discrimination part of the color sample is recognized to search the color sample appearing in the image, and the discrimination part is detected as the feature point. This configuration enables, for example, search of the color sample to be performed more appropriately with higher accuracy. For example, a part of the color sample can be used more appropriately as a feature point.

In this configuration, the shape and color of a plurality of target objects may be read simultaneously. In this case, for example, a plurality of images photographed in a state where the color sample is placed around each of the plurality of target objects may be used. In this case, in the shape data generation process, a plurality of three-dimensional shape data indicating the shape of the plurality of respective target objects is generated, for example, based on the plurality of images. In the color data generation process, a plurality of color data indicating the color of the plurality of respective target objects is generated, for example, based on the color of the plurality of images after correction is performed in the color correction process. This configuration enables, for example, the shape and color of a plurality of target objects to be read efficiently and appropriately. In this case, in the color correction process, color correction of the plurality of images is performed, for each of the plurality of target objects, for example, based on the color indicated in the image by the color sample discovered in the color sample search process. To perform color correction for each target object is, for example, to vary the way of performing the color correction depending on the target object.

The configuration of this invention may also use a three-dimensional-body data generation method, a program, a modeling system, and the like that have the same features as those described above. Also in these cases, for example, it is possible to achieve the same effects as those described above. In this case, the modeling system is a system including, for example, three-dimensional data and a shaping device. In the modeling system, the shaping device performs shaping of the three-dimensional object based on the three-dimensional shape data and the color data generated by the three-dimensional-body data generation device, for example.

### Effect of the Invention

According to this invention, it is possible to appropriately read the shape and color of a three-dimensional target object with high accuracy.

### BRIEF DESCRIPTION OF THE DRAWINGS

FIG. 1 are views showing one example of a configuration of a modeling system 10 according to one embodiment of this invention, in which, (a) of FIG. 1 shows one example of a configuration of the modeling system 10, and (b) of FIG. 1 shows one example of a configuration of a main part of a photographing device 12 in the modeling system 10.

FIG. 2 are views giving a more detailed explanation on how to photograph a target object 50 with the photographing device 12, in which, (a) of FIG. 2 shows one example of a state of the target object 50 at the time of photographing, and (b) of FIG. 2 shows one example of a configuration of a color target 60 used at the time of photographing the target object 50.

FIG. 3 are views showing an example of an image obtained by photographing the target object 50 by the photographing device 12, in which, (a) to (d) of FIG. 3 show examples of a plurality of images photographed by a single camera 104 in the photographing device 12.

FIG. 4 is a flowchart showing one example of an operation of generating three-dimensional shape data and color data.

FIG. 5 are views explaining a variation of the operation performed by the modeling system 10, in which, (a) and (b) of FIG. 5 show one examples a state of the target object 50 and the color target 60 at the time of photographing in the variation.

FIG. 6 are views showing various examples of the target object 50 of photography by the photographing device 12, in which, (a) and (b) of FIG. 6 show various examples of the shape of the target object 50 together with the single camera 104 in the photographing device 12.

FIG. 7 are views showing an example of the target object 50 having a more complicated shape, in which, (a) to (c) of FIG. 7 show examples of the shape and pattern of a vase used as the target object 50.

FIG. 8 are views showing one example of a configuration of a shaping device 16 in the modeling system 10, in which, (a) of FIG. 8 shows one example of a configuration of a main part of the shaping device 16, and (b) of FIG. 8 shows one example of a configuration of a head portion 302 in the shaping device 16.

### DESCRIPTION OF EMBODIMENTS

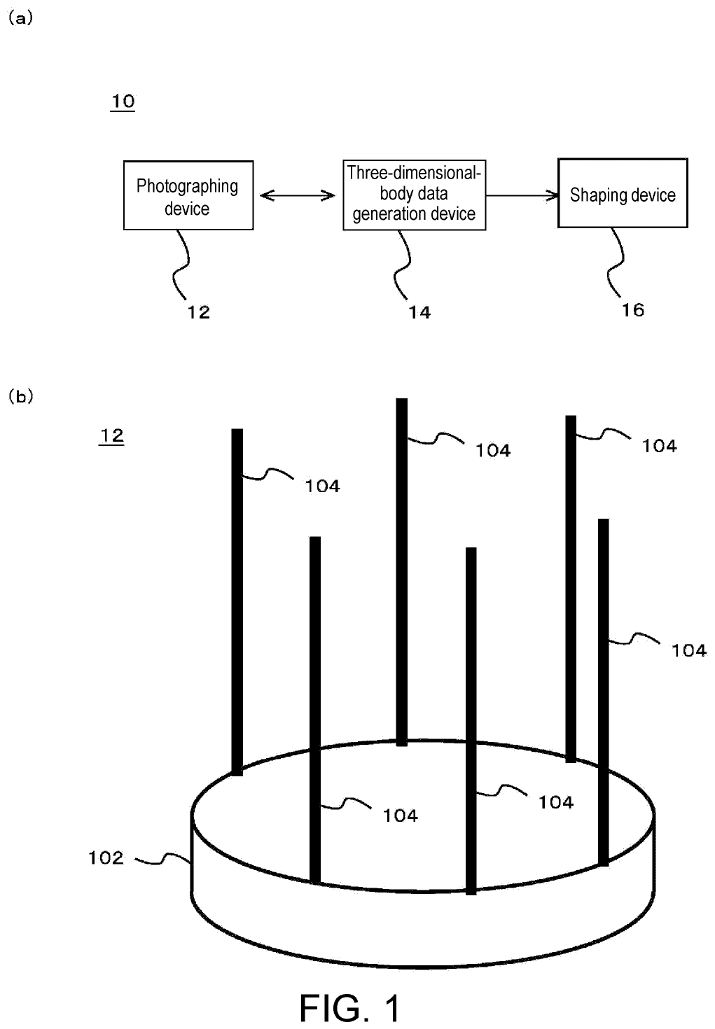

An embodiment according to this invention will be described below with reference to the drawings. FIG. 1 shows one example of a configuration of the modeling system 10 according to one embodiment of this invention. (a) of FIG. 1 shows one example of a configuration of the modeling system 10. (b) of FIG. 1 shows one example of a configuration of a main part of a photographing device 12 in the modeling system 10. In this example, the modeling system 10 is a system that performs reading of the shape and color of a three-dimensional target object and shaping a three-dimensional shaped object, and includes the photographing device 12, a three-dimensional-body data generation device 14, and the shaping device 16.

The photographing device 12 is a device that photographs (captures) an image (camera image) of a target object from a plurality of viewpoints. In this case, the target object is, for example, a three-dimensional object used in the modeling system 10 as a target whose shape and color are to be read. In this example, as shown in (b) of FIG. 1, the photographing device 12 includes a stage 102 that is a table on which the photography target object is placed, and a plurality of cameras 104 that photograph images of the target object. In this example, not only the target object but also a color target is placed on the stage 102. The features of the color target and the reason for using the color target will be described in more detail later.

The plurality of cameras 104 are placed at mutually different positions to photograph the target object from mutually different viewpoints. More specifically, in this example, the plurality of cameras 104 are placed at mutually different positions on a horizontal plane so as to surround the periphery of the stage 102, and thus photograph the target object from mutually different positions on the horizontal plane. Due to this, each of the plurality of cameras 104 photographs the target object placed on the stage 102 from each position surrounding the periphery of the target object. In this case, each camera 104 photographs the image so that at least a part thereof overlaps an image photographed by another camera 104. In this case, that at least a part of an image photographed by the camera 104 overlaps means, for example, that the visual fields of the plurality of cameras 104 overlap each other.

Each camera 104 has a shape in which the vertical direction is a longitudinal direction, for example, as shown in the figure, and photographs a plurality of images in which mutually different positions in the vertical direction are centers. In this case, the camera 104 may have, for example, a configuration having a plurality of lenses and imaging elements.

By using the photographing device 12 having such a configuration, the photographing device 12 acquires a plurality of images obtained by photographing a three-dimensional target object from mutually different viewpoints. More specifically, in this example, the photographing device 12 photographs a plurality of images used at least in a case of estimating the shape of the target object by, for example, a photogrammetry method. In this case, the photogrammetry method is, for example, a method of photographic measurement in which the dimensions and shape are obtained by analyzing parallax information from two-dimensional images obtained by photographing a three-dimensional target object from a plurality of observation points. In this example, the photographing device 12 photographs a plurality of color images. In this case, the color image is, for example, an image (e.g., full-color image) in which a component of a color corresponding to a predetermined basic color (e.g., each color of RGB) is expressed by a plurality of levels of gradation. As the photographing device 12, for example, the identical or similar device to the photographing device used in a known 3D scanner or the like can be suitably used.

The three-dimensional-body data generation device 14 is a device that generates three-dimensional shape data (3D shape data), which is data showing the three-dimensional shape of a target object, photographed by the photographing device 12, and generates three-dimensional shape data based on a plurality of images photographed by the photographing device 12. Except for the points described below, in this example, the photographing device 12 generates three-dimensional shape data by a known method such as a photogrammetry method. The three-dimensional-body data generation device 14 further generates color data, which is data indicating the color of the target object, in addition to the three-dimensional shape data, based on the plurality of images photographed by the photographing device 12.

Note that in this example, the three-dimensional-body data generation device 14 is a computer that operates in accordance with a predetermined program, and performs an operation of generating three-dimensional shape data and color data based on the program. In this case, the program executed by the three-dimensional-body data generation device 14 can be regarded as a combination of software that implements various functions described below, for example. The three-dimensional-body data generation device 14 can be regarded as an example of a device that executes a program, for example. The operation of generating three-dimensional shape data and color data will be described in more detail later.

The shaping device 16 is a shaping device that shapes a three-dimensional shaped object. In this example, the shaping device 16 shapes a colored shaped object based on the three-dimensional shape data and the color data generated by the three-dimensional-body data generation device 14. In this case, the shaping device 16 receives data including three-dimensional shape data and color data from the three-dimensional-body data generation device 14, for example, as data indicating the shaped object. Then, the shaping device 16 shapes a shaped object, for example, having a colored surface based on shaping data and color data. As the shaping device 16, a known shaping device can be suitably used. More specifically, as the shaping device 16, for example, a device that shapes a shaped object by a layered shaping method using ink of a plurality of colors as a shaping material can be suitably used. In this case, the shaping device 16 shapes the colored shaped object by ejecting ink of each color by an inkjet head, for example.

More specifically, in this example, the shaping device 16 shapes a shaped object having a colored surface by using at least ink of each process color (e.g., each color of cyan, magenta, yellow, and black). The surface is colored in full color. In this case, coloring in full color means, for example, coloring in various colors including an intermediate color obtained by mixing a plurality of colors of a shaping material (e.g., ink). In this case, the shaping device 16 used in this example can be regarded as, for example, a full-color 3D printer that outputs a shaped object colored in full color.

By using the modeling system 10 having the above-described configuration, for example, the photographing device 12 and the three-dimensional-body data generation device 14 can appropriately generate three-dimensional shape data and color data indicating the target object. By shaping a shaped object by the shaping device 16 using the three-dimensional shape data and the color data, it is possible to appropriately shape a shaped object indicating the target object, for example.

Note that except for the points described above and described below, the modeling system 10 in this example may have the identical or similar features to a known modeling system. As described above, in this example, the modeling system 10 includes three devices of the photographing device 12, the three-dimensional-body data generation device 14, and the shaping device 16. However, in a variation of the modeling system 10, functions of a plurality of these devices may be implemented by a single device. The function of each device may also be implemented by a plurality of devices. In the configuration of the modeling system 10, a combined part of the photographing device 12 and the three-dimensional-body data generation device 14 can be regarded as an example of a shaping data generation system, for example.

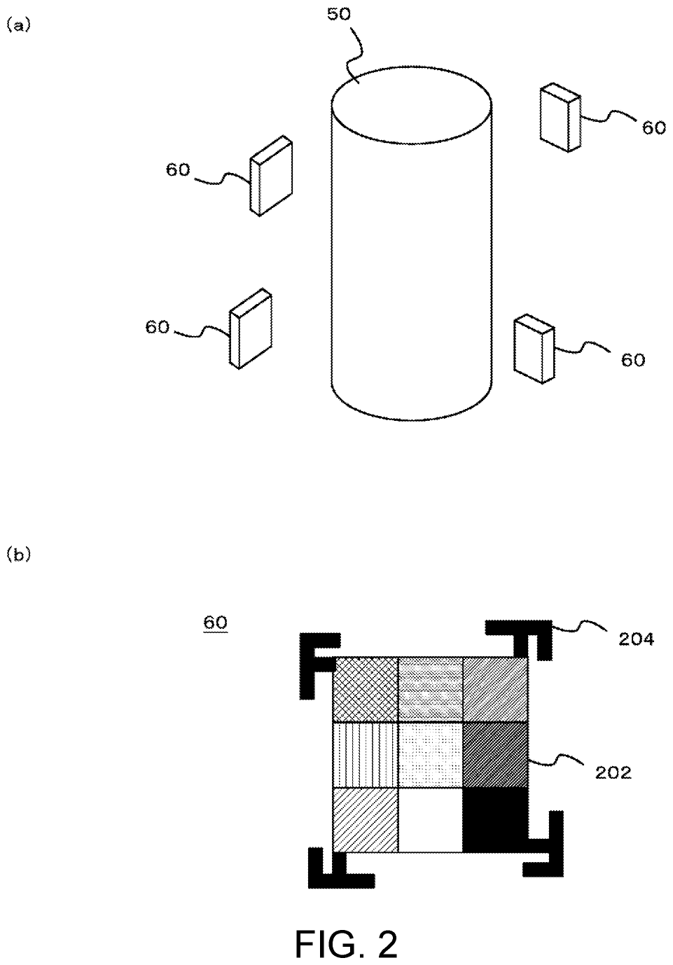

Next, how to photograph a target object by the photographing device 12 will be described in more detail. FIG. 2 are views giving a more detailed explanation on how to photograph the target object 50 with the photographing device 12. (a) of FIG. 2 shows one example of a state of the target object 50 at the time of photographing. (b) of FIG. 2 shows one example of a configuration of a color target 60 used at the time of photographing the target object 50.

As described above, in this example, when the target object 50 is photographed by the photographing device 12 (see FIG. 1), the color target 60 is further placed on the stage 102 (see FIG. 1) in addition to the target object 50. In this case, a plurality of images obtained by photographing the target object 50 by the photographing device 12 can be regarded as images photographed in a state where the color target 60 is placed around the target object 50, for example. More specifically, in this example, as shown in (a) of FIG. 2, for example, a plurality of images are photographed in a state where a plurality of color targets 60 are placed around the target object 50.

In this example, each of the plurality of color targets 60 is placed at a discretionary position around the target object 50. In this case, each color target 60 is placed at any position in the photographing environment (e.g., an environment background, a floor, and the like) so as to be photographed by any of the plurality of cameras 104 (see FIG. 1). This configuration enables a plurality of images in which each color target 60 is appearing in any image to be acquired as a plurality of images photographed by the photographing device 12, for example. At least some of the plurality of color targets 60 may be placed, for example, at a part where color is important in the target object 50 or at a position where the way the color is seen is liable to change due to the influence of the way the target object is exposed to light. In this case, the part where color is important in the target object 50 is, for example, a part where color reproduction is important when shaping a shaped object that reproduces the target object 50.

In this example, the color target 60 is an example of a color sample indicating a preset color. As the color target 60, for example, a color chart indicating a plurality of preset colors can be suitably used. As such a color chart, a color chart identical or similar to a color chart used in a commercially-available, known color target can be suitably used.

More specifically, in this example, a color target having a patch part 202 and a plurality of markers 204, as shown in (b) of FIG. 2, is used as the color target 60. In this case, the patch part 202 is a part constituting a color chart in the color target 60, and includes a plurality of color patches indicating mutually different colors. Note that, for convenience of illustration, (b) of FIG. 2 expresses a difference in color by a difference in shading pattern, thereby indicating a plurality of color patches having mutually different colors. The patch part 202 can be regarded as, for example, a part corresponding to image data used for color correction.

The plurality of markers 204 are members used for discriminating the color target 60, and are placed around the patch part 202, for example, as shown in the figure. By using such the markers 204, the color target 60 can be appropriately detected with high accuracy in an image obtained by photographing the target object 50. In this example, each of the plurality of markers 204 is an example of the discrimination part indicative of being the color target 60. As the marker 204, for example, a marker identical or similar to a known marker (image discrimination marker) used for image discrimination may be used. In this example, each of the plurality of markers 204 has a predetermined same shape as shown in the figure, for example, and is attached to a position of the four corners of the quadrilateral patch part 202 with mutually different orientations.

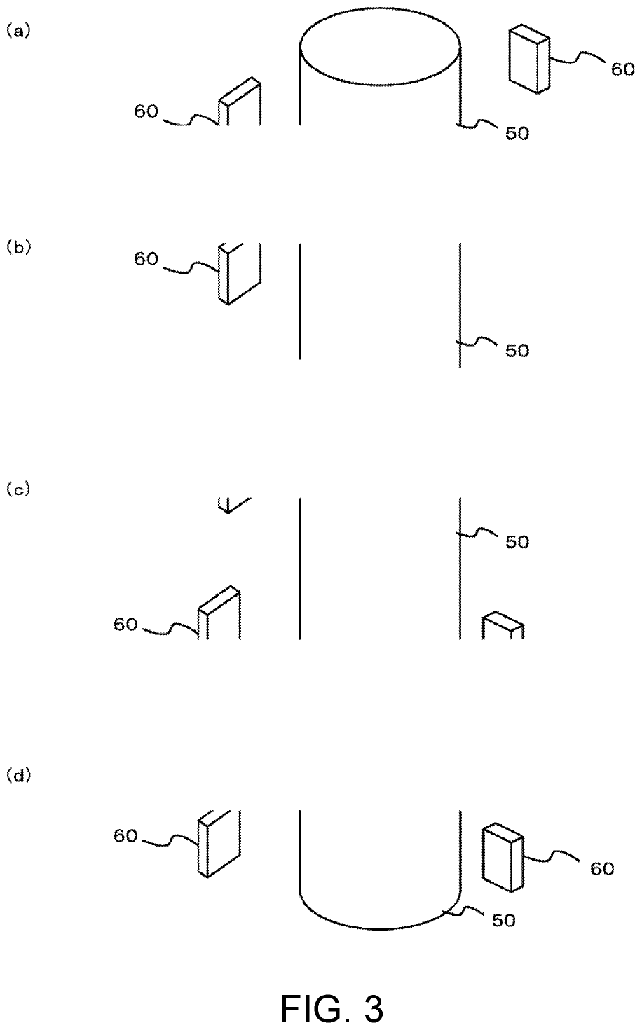

Next, an example of an image obtained by photographing the target object 50 by the photographing device 12 will be described. FIG. 3 are views showing an example of an image obtained by photographing the target object 50 by the photographing device 12. (a) to 3(d) of FIG. 3 show examples of a plurality of images photographed by the single camera 104 (see FIG. 1) in the photographing device 12. In this case, the single camera 104 is, for example, a camera placed at one position on a horizontal plane. As described above, in the photographing device 12 of this example, each camera 104 photographs a plurality of images centered at mutually different positions in the vertical direction.

In this case, the one camera 104 photographs a plurality of images in which a part of the vertical direction overlaps, for example, as shown in (a) to (d) of FIG. 3, from a viewpoint of viewing the target object 50 and the plurality of color targets 60 from one position on the horizontal plane. In this case, another camera photographs a plurality of images in which a part of the vertical direction overlaps, similarly from a viewpoint of viewing the target object 50 and the plurality of color targets 60 from another position on the horizontal plane. According to this example, for example, the plurality of cameras 104 can appropriately photograph a plurality of images indicating the entire target object 50.

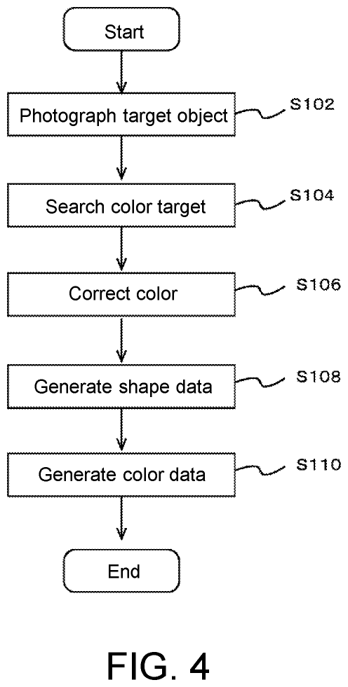

Next, the operation of generating the three-dimensional shape data and the color data will be described in more detail. FIG. 4 is a flowchart showing one example of an operation of generating three-dimensional shape data and color data.

When the three-dimensional shape data and the color data indicating the shape and color of a target object are generated in this example, first, as described above, a plurality of images are acquired (S102) by photographing the target object 50 (see FIG. 2) by the photographing device 12 (see FIG. 1) in a state where a plurality of color targets 60 (see FIG. 2) are placed around the target object. Based on these plurality of images, the three-dimensional shape data and the color data are generated by the three-dimensional-body data generation device 14 (see FIG. 1).

In this case, the three-dimensional-body data generation device 14 performs a process of searching a plurality of images for the color target 60 (S104). In this case, the operation of step S104 is an example of the operation of the color sample search process. In this example, the three-dimensional-body data generation device 14 finds the color target 60 by performing a process for detecting the image for the marker 204 in the color target 60. This configuration enables, for example, the color target 60 to be searched more easily and reliably.

As can be understood from the example of the image shown in FIG. 3, for example, only a part of the color target 60 is appearing in some images photographed by the photographing device 12. Therefore, in step S104, it is preferable to determine whether or not the entirety of the color target 60 discovered in the image appears. In this case, for example, whether or not the entirety of the color target 60 appears may be determined based on the number of appearing markers 204 in each color target 60.

In this case, also when only some markers 204 of the plurality of markers 204 in the single color target 60 appear in the image, for example, it may be determined that the color target 60 appears in the image. In this case, the color target 60 in which all the markers 204 appear and the color target 60 in which only some of the markers 204 appear may be distinguished. In this case, for example, the color target 60 in which only some of the markers 204 appear may be used supplementarily

The color target 60 does not necessarily appear in all of the plurality of images, and it may happen that the color target 60 appears only in some of the images. Therefore, the operation of step S104 can be regarded as an operation of searching the color target 60 appearing in the image in at least any of the plurality of images, for example.

As described above, in this example, each of the plurality of color targets 60 is placed at a discretionary position around the target object 50. Therefore, in step S104, the color sample is searched in a state where the position of the color target 60 in the image is unknown. The state where the position of the color target 60 in the image is unknown is, for example, a state where whereabout of the color target 60 in the image is unknown. In this case, it is also possible to consider that by searching the color target 60 in this way, the color target 60 can be placed at various positions in accordance with the shape or the like of the target object 50.

In this example, at least a part of the color target 60 in the image is used as a feature point of the image. In this case, the feature point is, for example, a point having a preset feature in the image. The feature point can also be regarded a point used as a reference position in an image process or the like, for example. More specifically, in step S104 of this example, the three-dimensional-body data generation device 14 extracts each of the plurality of markers 204 in the color target 60 as a feature point. In this case, the operation of the three-dimensional-body data generation device 14 can be regarded as, for example, an operation of recognizing the marker 204 of the color target 60 to search the color target 60 and detect the marker 204 as a feature point. This configuration enables, for example, search of the color target 60 to be appropriately performed with high accuracy. A part of the color target 60 can be appropriately used as a feature point.

The operation of step S104 may be executed by, for example, causing the three-dimensional-body data generation device 14 to read, into color correction software, a plurality of images acquired by the photographing device 12, and then performing an image analysis process. In this case, for example, the color correction software extracts, from the read image, a region (hereinafter referred to as color target region) including the color target 60. In this operation, determination of an extraction region, distortion correction process for an extracted image, and the like are performed using the plurality of markers 204 in the color target 60, for example. To use the plurality of markers 204 may mean to use the markers 204 in order to assist in these processes.

Following the operation in step S104, the three-dimensional-body data generation device 14 performs correction of color (color correction) (step S106) for the plurality of images photographed in step S102. In this case, the operation in step S106 is an example of the operation of the color correction process. In step S106 of this example, the three-dimensional-body data generation device 14 performs color correction of the plurality of images based on the color indicated in the image by the color target 60 discovered in the image in step S104. In this case, the color indicated in the image by the color target 60 is the color indicated in the image by each of the plurality of color targets 60.

In this case, the operation of step S106 may be executed by the color correction software in which the plurality of images are read in step S104. In this case, the color correction software acquires (samples) the color of the color patch constituting the color target 60 for the color target region extracted in step S104, for example. Then, a difference between the color obtained by the sampling and the original color to be indicated by the color patch at the position is calculated. The original color to be indicated by the color patch at the position is, for example, a known color having been set for each position of the color target 60. In this case, a profile for performing color correction corresponding to the difference is created based on the difference calculated for each color patch. In this case, the profile is, for example, data that associates colors before and after correction. In the profile, for example, the color may be associated by a calculation formula, a correspondence table, or the like. As such a profile, a profile identical or similar to a known profile used for color correction can be used.

In this example, the color correction software further performs color correction for a plurality of images acquired by the photographing device 12 based on the created profile as the operation of step S106. In this case, as the color correction, for example, it is conceivable to perform correction so that the color becomes original color in each color patch of the color target 60 in the image. In this case, the color correction of each position of the image is performed by performing color correction targeting at a region set in accordance with the position of the color target 60, for example. Thus, a plurality of images for which color correction has been performed are acquired. This configuration makes it possible to appropriately perform correction of approximating the original color for a plurality of images, for example.

Here, as the region set in accordance with the position of the color target 60, for example, it is conceivable to set the entire image in which the color target appears. As the region set in accordance with the position of the color target 60, for example, a partial region of the image may be set in accordance with a preset method of dividing the region or the like. The operation of color correction performed in this example can be regarded as, for example, an operation of color matching.

More specifically, in step S106 of this example, for example, each image is corrected based on the profile created corresponding to the color target 60 appearing in the image. In this case, an image in which no color target 60 appears is preferably corrected based on the profile created corresponding to the color target 60 appearing in any other image. When a plurality of color targets 60 appear in one image, it is conceivable to set a region for each color target 60, and to perform correction for each region based on the profile created corresponding to each color target 60. For example, when the same color target 60 appears in a plurality of images, the color difference between the images may be adjusted based on the color difference in the color target 60 expressed in each image. When a plurality of color targets 60 appear in one image, only some (e.g., any one) of the plurality of color targets 60 may be selected based on a preset reference, and the correction process may be performed based on the profile created corresponding to the selected color target 60. In this case, for example, it is conceivable to select the color target 60 appearing at a position closest to the center of the image.

The plurality of images and the color target 60 may be associated not in units of image but by dividing the entire range indicated by the plurality of images into a plurality of regions and associating any color target 60 with each region. In this case, for example, the range indicated by the plurality of images may be divided into a plurality of mesh-like regions, and each region may be associated with any color target 60. In this case, correction may be performed on a part corresponding to each region in the plurality of images based on the profile created corresponding to the color target 60 corresponding to the region.

Following the operation of step S106, the three-dimensional-body data generation device 14 generates (step S108) three-dimensional shape data based on the plurality of images photographed in step S102. In this case, the operation of step S108 is an example of the operation of the shape data generation process. In the operation of step S108 of this example, to be based on the plurality of images photographed in step S102 means that to be based on the plurality of images after correction is performed in step S106. In the variation of the operation of step S108, to be based on the plurality of images photographed in step S102 means that to be based on the plurality of images before correction is performed in step S106.

In this example, the three-dimensional-body data generation device 14 generates three-dimensional shape data by using the feature point extracted in step S104. To generate three-dimensional shape data by using a feature point is, for example, to perform a process of connecting a plurality of images (a process of synthesizing images) using the feature point as a reference position in the operation of generating the three-dimensional shape data. As described above, in this example, three-dimensional shape data is generated using a photogrammetry method, for example. In this case, the feature point may be used in the analysis process performed in the photogrammetry method, for example. More specifically, in the photogrammetry method, for example, as a point at a previous stage of obtaining parallax information, it is necessary to find mutually corresponding points (pixels) in images of a plurality of mutually different viewpoints (e.g., two viewpoints). The feature point may be used as a portion corresponding to such a point. The feature point may be used not limited in the process of synthesizing images but in the process of adjusting the positional relationship between a plurality of images, for example.

Except for use of a part of the color target 60 as a feature point in step S108 of this example and use of the plurality of images after correction is performed in step S106, three-dimensional shape data may be generated in a manner identical or similar to a known method, for example. In this case, a known method is, for example, a known method related to a method of three-dimensional shape estimation (3D scan). More specifically, as a known method, for example, the photogrammetry method or the like can be suitably used. As the three-dimensional shape data, data indicating a three-dimensional shape in a known format (e.g., a general-purpose format) may be generated.

In this example, estimation of the three-dimensional position corresponding to a pixel in an image is performed, for example, based on a feature point appearing in a plurality of images, parallax information obtained from the plurality of images, and the like. In this case, for example, the three-dimensional shape data may be obtained, for example, by causing software that performs the photogrammetry process to read data of a plurality of images (acquired image data) and to perform various calculations. According to this example, for example, generation of three-dimensional shape data can be appropriately performed with high accuracy.

Following the operation of step S108, the three-dimensional-body data generation device 14 performs a process of generating color data, which is data indicating the color of the target object 50 (step S110). In this case, the operation of step S110 is an example of the operation of the color data generation process. In this example, the three-dimensional-body data generation device 14 generates color data based on the color of the plurality of images after correction is performed in step S106. In this case, for example, data indicating the color of each position of the target object 50 in association with the three-dimensional shape data is generated as the color data.

More specifically, in this example, data indicating a texture indicating the color of the surface of the target object 50, for example, is generated, as the color data. In this case, the color data may be regarded as data indicating a texture attached to the surface of the three-dimensional shape indicated by the three-dimensional shape data, for example. Such color data can be regarded as an example of data indicating the color of the surface of the target object 50, for example. The process of generating color data based on the plurality of images in step S110 can be performed in the manner identical or similar to the known method except for the use of a plurality of images after correction is performed in step S106.

According to this example, three-dimensional shape data and color data can be automatically and appropriately generated based on a plurality of images acquired by the photographing device 12, for example. In this case, by automatically finding out the color target 60 appearing in a plurality of images, color correction can also be automatically and appropriately by automatically creating a profile used for correction, for example. This enables three-dimensional shape data and color data to be appropriately generated, for example, in a state where color correction is appropriately performed with higher accuracy. In this case, the operation of color correction performed in this example can be regarded as an automated method of color correction performed in the process of generating a full color three-dimensional model (full color 3D model) by the photogrammetry method or the like, for example.

As described above, in this example, the shaping device 16 shapes a full-colored shaped object based on the three-dimensional shape data and the color data generated by the three-dimensional-body data generation device 14. In such a case, if the plurality of images acquired by the photographing device 12 are out of color registration or the like, the shaped object to be shaped will also be unintentionally out of color registration.

More specifically, for example, when the photographing device 12 photographs the three-dimensional target object 50, the way the color is seen may vary depending on the position of the target object 50 due to the influence of the way the target object 50 is exposed to light. For example, depending on the characteristics of the imaging elements in the plurality of cameras 104 to be used, the white balance, and the like, an image having a color tone different from the actual appearance is sometimes photographed. In such a case, if color data is generated by using the plurality of images acquired by the photographing device 12 as they are, color data indicating a color different from the original color will be generated. As a result, the shaped object to be shaped will also be unintentionally out of color registration.

On the other hand, in this example, for example, by automatically performing color correction using a plurality of images obtained by photographing the color target 60 and the target object 50, it is possible to appropriately perform color correction so that the color of the image approaches the actual appearance even when the image obtained by photographing the target object 50 is out of color registration. Thus, it is possible to appropriately read the shape and color of the target object 50, for example, with high accuracy, and appropriately generate three-dimensional shape data and color data. By performing the operation of shaping in the shaping device 16 using such the three-dimensional shape data and the color data, it is possible to appropriately shape a high-quality shaped object.

In consideration of performing color correction using the color target 60 here, it seems that photography of the target object 50 and photography of the color target 60 are only required to be performed separately from each other, instead of placing the color target 60 around the target object 50. Also in this case, for example, if the color target 60 is photographed under the same photographing conditions as those in the photographing environment of the target object 50, it is possible to create a profile or the like to be used for color correction based on the image obtained by photographing the color target 60. By using thus created profile to correct an image in which the target object 50 appears, it is also possible to obtain an image in which the color is corrected to the one as it originally appears.

However, when the photography of the color target 60 and the photography of the target object 50 are performed separately as described above, the labor required for a series of works required for performing color correction of the image will greatly increase. Such a work needs to be performed every time the photographing environment such as a device to be used and a lighting condition changes. Therefore, it is desired to save labor as much as possible in the work performed for color correction. On the other hand, in this example, by using a plurality of images photographed in a state where the color target 60 is arranged around the target object 50, the color correction process can be appropriately automated as described above. This can greatly save the work required for color correction.

Note that, regarding the operation of performing color correction, it seems that for example, the process of searching the color target 60, color adjustment, and the like are not necessarily be automatically performed, but they are only required to be performed by manual operation by the user while appropriately receiving an instruction from the user via a user interface such as a mouse, a keyboard, and a touchscreen. However, in the case where a plurality of images are acquired for the single target object 50 as in this example, performing color correction by the user's manual operation will greatly increase the user's labor.

As described above, in this example, each color target 60 is placed at a discretionary position around the target object 50 by using the plurality of color targets 60. In such a case, performing color correction by the user's manual operation will particularly greatly increase the user's labor. There also is a risk of overlooking the color target 60. On the other hand, in this example, by automatically performing color correction as described above, color correction can be appropriately performed with high accuracy without imposing a large burden on the user.

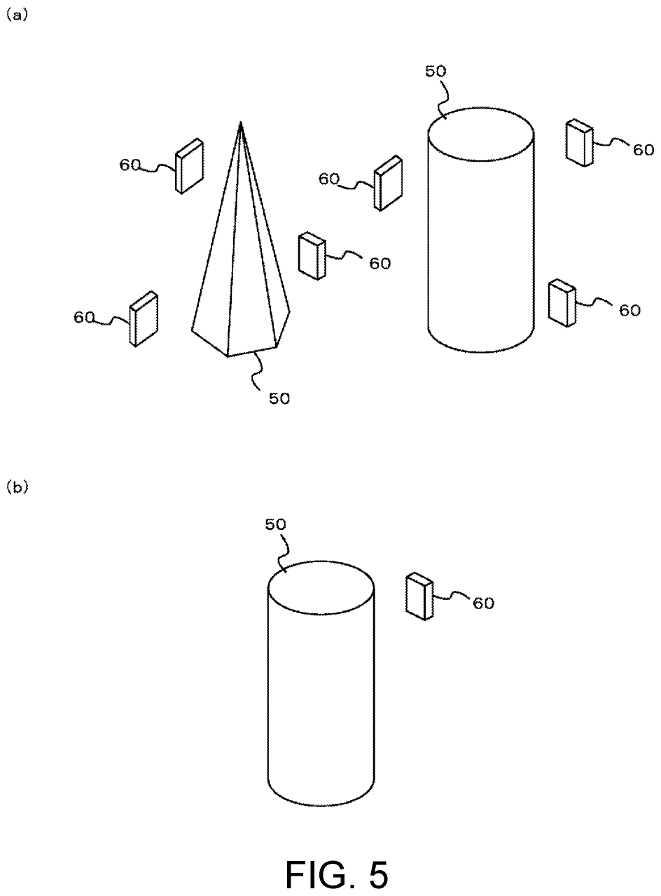

Next, a variation of the operation performed in the modeling system 10 and a supplementary explanation regarding each configuration described above will be given. FIG. 5 are views explaining a variation of the operation performed by the modeling system 10. (a) and (b) of FIG. 5 show one examples a state of the target object 50 and the color target 60 at the time of photographing in the variation.

In the above, the operation in the case where only the single target object 50 is used as a target of photography by the photographing device 12 (see FIG. 1) has been mainly described. However, in a variation of the operation performed by the modeling system 10, for example, as shown in (a) of FIG. 5, it is also conceivable to simultaneously read the shape and color of the plurality of target objects 50. In this case, the plurality of target objects 50 are simultaneously placed on the stage 102 (see FIG. 1) in the photographing device 12, and photography is performed by the plurality of cameras 104 (see FIG. 1). In this case, for example, as shown in the figure, the photography is performed in a state where the plurality of color targets 60 are placed around each target object 50. Thus, as a plurality of images used in the three-dimensional-body data generation device 14, a plurality of images photographed in a state where the color target 60 is placed around each of the plurality of target objects 50 are acquired.

In this case, in the process of generating three-dimensional shape data (shape data generation process) in the three-dimensional-body data generation device 14, a plurality of three-dimensional shape data indicating the shapes of the plurality of respective target objects 50 are generated based on a plurality of images, for example. In the process of generating color data (color data generation process), a plurality of color data indicating the color of the plurality of respective target objects 50 are generated based on the color of the plurality of images after performing color correction, for example. This configuration enables, for example, the shape and color of the plurality of target objects 50 to be read efficiently and appropriately.

In this case, in the process of color correction (color correction process) performed before color data is generated, color correction of a plurality of images may be performed, for example, for each of the plurality of target objects 50 based on the color indicated in the image by the color target 60 discovered in the process of searching the color target 60 (color sample search process). To perform color correction for each target object 50 is, for example, to vary the way of performing the color correction depending on the target object 50. This configuration enables color correction to be performed more appropriately when the shape and color are simultaneously read for the plurality of target objects 50, for example.

In a case where the shape and color of the plurality of target objects 50 are simultaneously read, it is also possible to use a plurality of target objects 50 having greatly different colors. On the other hand, when color correction is performed for each target object 50, color correction can be performed more appropriately even in such a case. In this case, by placing the color target 60 around each target object 50, color correction corresponding to each target object 50 can be performed more appropriately. As a method of performing color correction for each target object 50, for example, a profile used for color correction may be created for each target object 50. In this case, for example, the color target 60 and the target object 50 may be associated with each other in advance, and color correction corresponding to each target object 50 may be performed using the color target 60 corresponding to the target object 50. In this case, the color targets 60 may be distinguished, for each target object 50, by varying the features (e.g., the shape and the like) of the markers 204 (see FIG. 2) in the color targets 60, for example.

In the above, an operation in the case where the plurality of color targets 60 are placed around the single target object 50 to perform photography has been mainly described. However, depending on the accuracy required for color correction only the single color target 60 may be placed around the single target object 50, as shown in (b) of FIG. 5, for example. Also in such a case, color correction can be appropriately performed based on the color of the color target 60 appearing in the plurality of images, for example.

Next, a supplementary explanation regarding each configuration described above will be given. In the following, for convenience of explanation, the configurations described above including the variation described with reference to FIG. 5 are collectively referred to as this example.

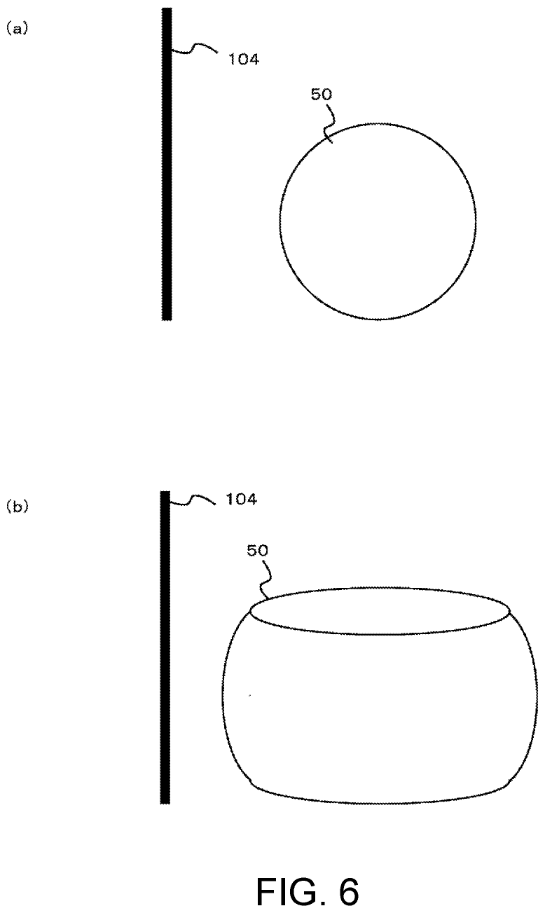

For convenience of illustration, FIG. 2 and FIG. 5, and the like illustrate the target object 50 having a relatively simple side surface shape. However, the photographing device 12 can also photograph the target object 50 having a more complicated shape. In this case, it is conceivable to use the target object 50 having a convex shape in which the side surface of the target object 50 toward the camera 104, as shown in FIG. 6, for example.

FIG. 6 are views showing various examples of the target object 50 of photography by the photographing device 12. (a) and (b) of FIG. 6 show various examples of the shape of the target object 50 together with the single camera 104 in the photographing device 12 (see FIG. 1). More specifically, the target object 50 shown in (a) of FIG. 6 is a spherical target object 50. In this case, the side surface of the target object 50 has a convex shape toward the camera 104, as shown in the figure. The spherical target object 50 may be regarded as, for example, an example of the target object 50 having a curved side surface. In this case, the fact that the side surface of the target object 50 is curved can be regarded as, for example, the fact that the part corresponding to the side surface of the target object 50 in the cross section of the plane parallel to the vertical direction is curved. As the target object 50 having a curved side surface, for example, the target object 50 in the shape of a table (pot) as shown in (b) of FIG. 6 may be used.

Even in a case of using the target object 50 having such a shape, use of the photographing device 12 described above enables photography of an image used for generation of three-dimensional shape data and color data to be appropriately performed. More specifically, as described above, in the photographing device 12 of this example, each camera 104 photographs a plurality of images centered at mutually different positions in the vertical direction. Therefore, the entire side surface can be appropriately photographed even when a part difficult to be seen by photography from one direction, for example, occurs on the side surface of the target object 50. When the side surface of the target object 50 has a convex shape, it is conceivable that a part of the side surface becomes less likely to be exposed to light. However, even in such a case, by placing the color target 60 (see FIG. 2) around the target object 50 as necessary, for example, color correction can be appropriately performed by the three-dimensional-body data generation device 14 (see FIG. 1).

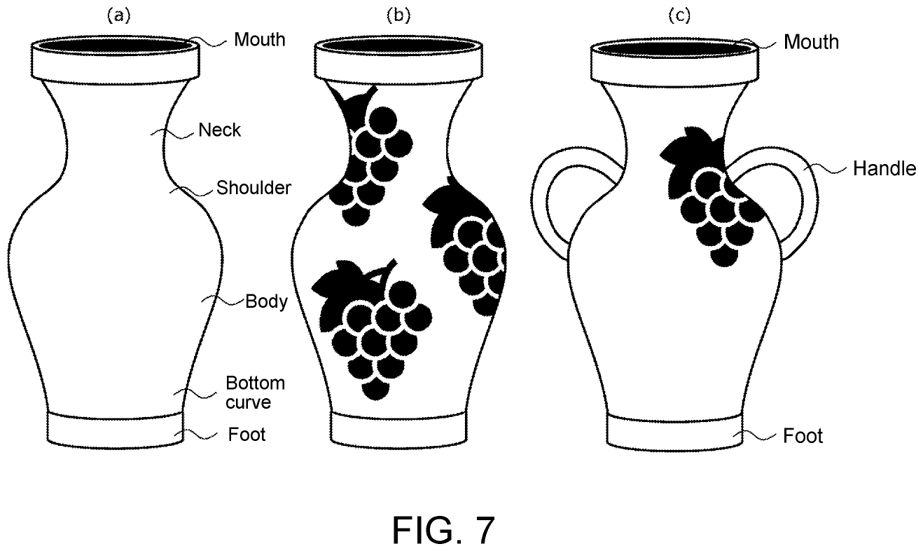

As the target object 50, an object with a more complicated shape may be used. For example, as the target object 50, a vase or the like having a complicatedly bent side surface may be used. FIG. 7 are views showing an example of the target object 50 having a more complicated shape. (a) to (c) of FIG. 7 show examples of the shape and pattern of a vase used as the target object 50.

In the case shown in the figure, a vase has various sites such as a mouth, a neck, a shoulder, a body, a bottom curve, and a foot, as shown in (a) of FIG. 7. The side surface of the vase is continuously bent while changing the curvature depending on the position so as to smoothly connect these sites. The vase may further have a handle site as shown in (c) of FIG. 7, for example. Various patterns may be drawn on the side surface of the vase, as shown in (b) and (c) of FIG. 7, for example. The target object 50 such as a vase can be regarded, for example, an object continuously bent in the gravity direction.

When using the target object 50 having a complicated shape such as a vase, the color of the surface may vary depending on the site due to the influence of shade (shadow) occurring by the positional relationship between the sites, for example. As a result, when a plurality of images of the same shape and same color are drawn on the surface of the vase, for example, as in the pattern of the vase shown in (b) of FIG. 7, the color in the image photographed by the camera 104 (see FIG. 2) may vary depending on whether the image is positioned at a part in shade or positioned at a part exposed to light. On the other hand, in a case of using the photographing device 12 described above, it is possible by photographing the target object 50 together with the color target 60 (see FIG. 2), to appropriately grasp a change in color due to a part of the target object 50, for example. Due to this, for example, color correction can be appropriately performed by the three-dimensional-body data generation device 14 (see FIG. 1).

In the photographing device 12 of this example, since appropriate photography of an image can be performed for the target object 50 having various shapes, further various objects may be used as the target object 50. For example, a living thing such as a human, a plant, and the like may be used as the photography target object 50. Works of art having various shapes may be used as the photography target object.

As described above, in this example, the color target 60 appearing in the image is used also as a feature point of the image. In this case, a configuration other than the color target 60, a pattern, and the like may be used as a feature point, as necessary. In a variation of the operation of the modeling system 10, the three-dimensional shape data and the color data may be generated without using the color target 60 as a feature point.

As described above, in this example, color correction can be appropriately performed for the color of the plurality of images even when a difference occurs between the color in the image and the original color of the three-dimensional object. Therefore, color correction can be appropriately performed even when there is a difference in the characteristics of the plurality of cameras 104 in the photographing device 12, for example. In this case, it can be regarded that the color correction performed in this example also corrects variations in the characteristics of the camera 104. In order to perform color correction with higher accuracy, it is preferable that the difference in characteristics of the cameras 104 be adjusted in advance to fall within a predetermined range.

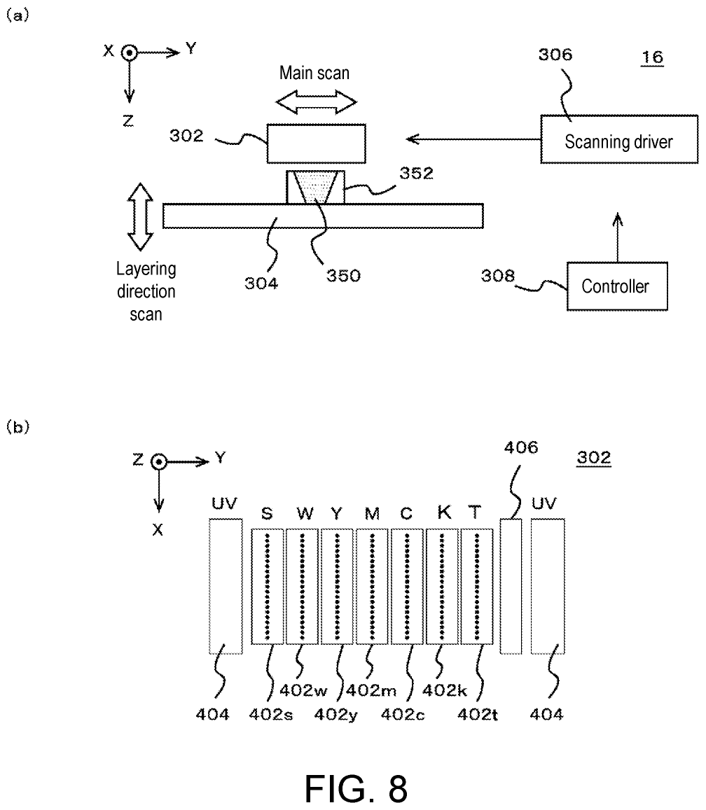

As described above, in the modeling system 10 of this example, three-dimensional shape data and color data indicating the target object 50 photographed by the photographing device 12 are generated by the shaping device 16, and the shaping device 16 (see FIG. 1) shapes a shaped object based on the three-dimensional shape data and color data. In this case, the shaping device 16 may shape a shaped object that indicates the target object 50 reduced in size. As described above, as the shaping device 16, for example, a device that shapes a shaped object by a layered shaping method using ink of a plurality of colors as a shaping material may be used. More specifically, the shaping device 16 may be, for example, a device including the configuration shown in FIG. 8.

FIG. 8 shows one example of a configuration of the shaping device 16 in the modeling system 10. (a) of FIG. 8 shows one example of a configuration of a main part of the shaping device 16. Except for the points described above and described below, the shaping device 16 may have the identical or similar features to a known shaping device. More specifically, except for the points described above and described below, the shaping device 16 may have the identical or similar features to a known shaping device that carries out shaping by ejecting a droplet that becomes the material of a shaped object 350 using an inkjet head. In addition to the illustrated configuration, the shaping device 16 may further include various configurations necessary for shaping of the shaped object 350, for example.

In this example, the shaping device 16 is a shaping device (3D printer) that shapes the three-dimensional shaped object 350 by a layered shaping method, and includes the head portion 302, a shaping table 304, a scanning driver 306, and a controller 308. The head portion 302 is a part that ejects the material of the shaped object 350. In this example, ink is used as the material of the shaped object 350. In this case, the ink is, for example, a functional liquid. More specifically, the head portion 302 ejects ink that cures in accordance with a predetermined condition from a plurality of inkjet heads as a material of the shaped object 350. Then, by curing the ink after the impact, each layer constituting the shaped object 350 is shaped in a layer. In this example, an ultraviolet-curable ink (UV ink), which cures from a liquid state by irradiation with ultraviolet is adopted as the ink. The head portion 302 further ejects the material of a support layer 352 in addition to the material of the shaped object 350. Thus, the head portion 302 forms the support layer 352 as necessary around the shaped object 350. The support layer 352 is, for example, a layer structural object supporting at least a part of the shaped object 350 under shaping. The support layer 352 is shaped as necessary during shaping of the shaped object 350, and is removed after the shaping is completed.

The shaping table 304 is a table-shaped member supporting the shaped object 350 under shaping, and is disposed at a position facing the inkjet head in the head portion 302, and the shaped object 350 under shaping and the support layer 352 are placed on the upper surface. In this example, the shaping table 304 has a configuration in which at least the upper surface can move in the layering direction (Z direction in the figure), and when driven by the scanning driver 306, the shaping table 304 moves at least the upper surface in accordance with the progress of the shaping of the shaped object 350. In this case, the layering direction can be regarded as a direction in which the shaping material is layered in the layered shaping method, for example. In this example, the layering direction is a direction orthogonal to a main scanning direction (Y direction in the figure) and a sub scanning direction (X direction in the figure) that are preset in the shaping device 16.

The scanning driver 306 is a driver that causes the head portion 302 to perform a scanning operation of moving relatively with respect to the shaped object 350 under shaping. In this case, to move relatively with respect to the shaped object 350 under shaping means move relatively with respect to the shaping table 304, for example. To cause the head portion 302 to perform a scanning operation means to cause the inkjet head of the head portion 302, for example, to perform a scanning operation. In this example, the scanning driver 306 causes the head portion 302 to perform main scan (Y scanning), sub scan (X scanning), and layering direction scan (Z scanning) as the scan.

The main scan is an operation of ejecting ink while moving relatively in the main scanning direction with respect to the shaped object 350 under shaping, for example. The sub scan is an operation of moving relatively to the shaped object 350 under shaping in a sub scanning direction orthogonal to the main scanning direction, for example. The sub scan may be regarded as an operation of moving relatively to the shaping table 304 in the sub scanning direction by a preset feed amount, for example. In this example, the scanning driver 306 fixes the position of the head portion 302 in the sub scanning direction between the main scan and moves the shaping table 304, thereby causing the head portion 302 to perform the sub scan. The layering direction scan is an operation of moving the head portion 302 in the layering direction relatively to the shaped object 350 under shaping, for example. The scanning driver 306 adjusts the relative position of the inkjet head with respect to the shaped object 350 under shaping in the layering direction by causing the head portion 302 to perform the layering direction scan in accordance with the progress of the shaping operation.

The controller 308 is configured to include a CPU of the shaping device 16, for example, and controls the shaping operation of the shaping device 16 by controlling each portion of the shaping device 16. More specifically, in this example, the controller 308 controls each portion of the shaping device 16 based on the three-dimensional shape data and the color data generated by the three-dimensional-body data generation device 14 (see FIG. 1).

In the shaping device 16, the head portion 302 has a configuration shown in (b) of FIG. 8, for example. (b) of FIG. 8 shows one example of a configuration of a head portion 302 in the shaping device 16. In this example, the head portion 302 includes a plurality of inkjet heads, a plurality of ultraviolet light sources 404, and a flattening roller 406. As shown in the figure, the head portion 302 has the plurality of inkjet heads including an inkjet head 402s, an inkjet head 402w, an inkjet head 402y, an inkjet head 402m, an inkjet head 402c, an inkjet head 402k, and an inkjet head 402t. The plurality of inkjet heads are arranged side by side in the main scanning direction, for example, with the position aligned in the sub scanning direction. Each inkjet head has a nozzle row in which a plurality of nozzles are arranged side by side in a predetermined nozzle row direction on a surface facing the shaping table 304. In this example, the nozzle row direction is a direction parallel to the sub scanning direction.

Of these inkjet heads, the inkjet head 402s ejects the material of the support layer 352. As the material of the support layer 352, for example, a known material for the support layer can be suitably used. The inkjet head 402w ejects white (W color) ink. In this case, the white ink is an example of a light reflective ink.

The inkjet head 402y, the inkjet head 402m, the inkjet head 402c, and the inkjet head 402k (inkjet heads 402 y to k) are coloring inkjet heads used when shaping the colored shaped object 350, and eject each ink of a plurality of color (coloring ink) used for coloring. More specifically, the inkjet head 402y ejects yellow (Y color) ink. The inkjet head 402m ejects magenta (M color) ink. The inkjet head 402c ejects cyan (C color) ink. The inkjet head 402k ejects black (K color) ink. In this case, each color of YMCK is an example of a process color used for full color representation. The inkjet head 402t ejects clear ink. The clear ink is an ink that is colorless and transparent (T) with respect to visible light, for example.

The plurality of ultraviolet light sources 404 are light sources (UV light sources) for curing the ink, and generate ultraviolet that cures the ultraviolet-curable ink. In this example, each of the plurality of ultraviolet light sources 404 is disposed on one end side and the other end side in the main scanning direction of the head portion 302 so as to sandwich the array of the inkjet heads in between. As the ultraviolet light source 404, for example, an ultraviolet LED (UVLED) or the like can be suitably used. A metal halide lamp, a mercury lamp, or the like may be used as the ultraviolet light source 404. The flattening roller 406 is a flattening means for flattening a layer of ink shaped during shaping of the shaped object 350. The flattening roller 406 flattens the layer of ink by coming into contact with the surface of the layer of ink and removing a part of the ink before curing at the time of the main scan, for example.

By using the head portion 302 having the above-described configuration, it is possible to appropriately shape the layer of ink constituting the shaped object 350. By shaping a plurality of layers of ink in a layer, the shaped object 350 can be appropriately shaped. In this case, the colored shaped object can be appropriately shaped by using the ink of each color described above. More specifically, the shaping device 16 shapes the colored shaped object by, for example, forming a region to be colored in a part constituting the surface of the shaped object 350 and shaping a light reflecting region inside the region to be colored. In this case, the region to be colored may be formed by using ink of each color of the process color and clear ink. In this case, the clear ink may be used for compensating for a change in the use amount of ink in the process color caused by a difference in the color to be colored for each position of the region to be colored, for example. The light reflecting region may be formed by using white ink, for example.

In the above, color correction has been explained, mainly focusing on the case where a three-dimensional object is subsequently shaped. However, the color correction performed similarly to the above can be suitably used other than in a case of shaping a three-dimensional object. For example, in the field of computer graphics (CG) or the like, when displaying a colored three-dimensional object or the like, three-dimensional shape data and color data may be generated by performing correction identical or similar to the above.

### INDUSTRIAL APPLICABILITY

This invention can be suitably used in a three-dimensional-body data generation device, for example.

### REFERENCE SIGNS LIST

10 Modeling system
12 Photographing device
14 Three-dimensional-body data generation device
16 Shaping device
50 Target object
60 Color target
102 Stage
104 Camera
202 Patch part
204 Marker
302 Head portion
304 Shaping table
306 Scanning driver
308 Controller
350 Shaped object
352 Support layer
402 Inkjet head
404 Ultraviolet light source
406 Flattening roller

1. A three-dimensional-body data generation device that generates a three-dimensional shape data that is a data indicating a three-dimensional shape of a target object which is three-dimensional based on a plurality of images obtained by photographing the target object from mutually different viewpoints, wherein the three-dimensional-body data generation device is configured to perform:
using, as the plurality of images, a plurality of images photographed in a state where a color sample indicating a preset color is placed around the target object;
a color sample search process of searching the color sample appearing in the image for at least any of the plurality of images;
a color correction process of performing color correction of the plurality of images based on a color indicated in the image by the color sample discovered in the color sample search process;
a shape data generation process of generating the three-dimensional shape data based on the plurality of images; and
a color data generation process of generating a color data that is a data indicating a color of the target object, a process of generating the color data based on a color of the plurality of images after correction is performed in the color correction process.

2. The three-dimensional-body data generation device as set forth in claim 1, wherein the three-dimensional-body data generation device is configured for:
using, as the plurality of images, a plurality of images photographed in a state where a plurality of the color samples is placed around the target object, and
in the color correction process, color correction of the plurality of images being performed based on a color indicated in the image by each of the plurality of color samples.

3. The three-dimensional-body data generation device as set forth in claim 1, wherein the three-dimensional-body data generation device is configured for:
in the color sample search process, at least a part of the color sample appearing in the image being detected as a feature point, and
in the shape data generation process, the three-dimensional shape data being generated based on the plurality of images by using the feature point.

4. The three-dimensional-body data generation device as set forth in claim 3, wherein the three-dimensional-body data generation device is configured for:
the color sample having a discrimination part indicative of being the color sample,
in the color sample search process, the discrimination part of the color sample being recognized to search the color sample appearing in the image, and
the discrimination part being detected as the feature point.

5. The three-dimensional-body data generation device as set forth in claim 1, wherein the three-dimensional-body data generation device is configured for:
the color sample being placed at a discretionary position around the target object, and
in the color sample search process, the color sample being searched in a state where a position of the color sample in the image is unknown.

6. The three-dimensional-body data generation device as set forth in claim 1, wherein the three-dimensional-body data generation device is configured for:
using, as the plurality of images, a plurality of images photographed in a state where the color sample is placed around each of a plurality of the target objects,
in the shape data generation process, a plurality of the three-dimensional shape data indicating a shape of the plurality of respective target objects being generated based on the plurality of images, and
in the color data generation process, a plurality of the color data indicating a color of the plurality of respective target objects being generated based on a color of the plurality of images after correction is performed in the color correction process.

7. The three-dimensional-body data generation device as set forth in claim 6, wherein the three-dimensional-body data generation device is configured for:
in the color correction process, color correction of the plurality of images being performed for each of the plurality of target objects based on a color indicated in the image by the color sample discovered in the color sample search process.

8. A three-dimensional-body data generation method of generating a three-dimensional shape data that is a data indicating a three-dimensional shape of a target object which is three-dimensional based on a plurality of images obtained by photographing the target object from mutually different viewpoints, the three-dimensional-body data generation method comprising:
using, as the plurality of images, a plurality of images photographed in a state where a color sample indicating a preset color is placed around the target object;
a color sample search process of searching the color sample appearing in the image for at least any of the plurality of images;
a color correction process of performing color correction of the plurality of images based on a color indicated in the image by the color sample discovered in the color sample search process;
a shape data generation process of generating the three-dimensional shape data based on the plurality of images; and
a color data generation process of generating a color data that is a data indicating a color of the target object, a process of generating the color data based on a color of the plurality of images after correction is performed in the color correction process.

9. (canceled)

10. A modeling system that shapes a three-dimensional shaped object, comprising:
a three-dimensional-body data generation device that generates a three-dimensional shape data that is a data indicating a three-dimensional shape of a target object which is three-dimensional based on a plurality of images obtained by photographing the target object from mutually different viewpoints; and
a shaping device that performs a shaping of a three-dimensional object,
wherein the three-dimensional-body data generation device is configured to perform:
using, as the plurality of images, a plurality of images photographed in a state where a color sample indicating a preset color is placed around the target object;
a color sample search process of searching the color sample appearing in the image for at least any of the plurality of images;
a color correction process of performing color correction of the plurality of images based on a color indicated in the image by the color sample discovered in the color sample search process;
a shape data generation process of generating the three-dimensional shape data based on the plurality of images; and
a color data generation process of generating a color data that is a data indicating a color of the target object, a process of generating the color data based on a color of the plurality of images after correction is performed in the color correction process,
wherein the shaping device is configured to perform the shaping of the three-dimensional object based on the three-dimensional shape data and the color data generated by the three-dimensional-body data generation device.

11. The three-dimensional-body data generation device as set forth in claim 2, wherein the three-dimensional-body data generation device is configured for:
in the color sample search process, at least a part of the color sample appearing in the image being detected as a feature point, and
in the shape data generation process, the three-dimensional shape data being generated based on the plurality of images by using the feature point.

12. The three-dimensional-body data generation device as set forth in claim 11, wherein the three-dimensional-body data generation device is configured for:
the color sample having a discrimination part indicative of being the color sample,
in the color sample search process, the discrimination part of the color sample being recognized to search the color sample appearing in the image, and
the discrimination part being detected as the feature point.

13. The three-dimensional-body data generation device as set forth in claim 2, wherein the three-dimensional-body data generation device is configured for:
the color sample being placed at a discretionary position around the target object, and
in the color sample search process, the color sample being searched in a state where a position of the color sample in the image is unknown.

14. The three-dimensional-body data generation device as set forth in claim 3, wherein the three-dimensional-body data generation device is configured for:
the color sample being placed at a discretionary position around the target object, and
in the color sample search process, the color sample being searched in a state where a position of the color sample in the image is unknown.

15. The three-dimensional-body data generation device as set forth in claim 4, wherein the three-dimensional-body data generation device is configured for:
the color sample being placed at a discretionary position around the target object, and
in the color sample search process, the color sample being searched in a state where a position of the color sample in the image is unknown.

16. The three-dimensional-body data generation device as set forth in claim 2, wherein the three-dimensional-body data generation device is configured for:
using, as the plurality of images, a plurality of images photographed in a state where the color sample is placed around each of a plurality of the target objects,
in the shape data generation process, a plurality of the three-dimensional shape data indicating a shape of the plurality of respective target objects being generated based on the plurality of images, and
in the color data generation process, a plurality of the color data indicating a color of the plurality of respective target objects being generated based on a color of the plurality of images after correction is performed in the color correction process.

17. The three-dimensional-body data generation device as set forth in claim 3, wherein the three-dimensional-body data generation device is configured for:
using, as the plurality of images, a plurality of images photographed in a state where the color sample is placed around each of a plurality of the target objects,
in the shape data generation process, a plurality of the three-dimensional shape data indicating a shape of the plurality of respective target objects being generated based on the plurality of images, and
in the color data generation process, a plurality of the color data indicating a color of the plurality of respective target objects being generated based on a color of the plurality of images after correction is performed in the color correction process.

18. The three-dimensional-body data generation device as set forth in claim 4, wherein the three-dimensional-body data generation device is configured for:
using, as the plurality of images, a plurality of images photographed in a state where the color sample is placed around each of a plurality of the target objects,
in the shape data generation process, a plurality of the three-dimensional shape data indicating a shape of the plurality of respective target objects being generated based on the plurality of images, and
in the color data generation process, a plurality of the color data indicating a color of the plurality of respective target objects being generated based on a color of the plurality of images after correction is performed in the color correction process.

19. The three-dimensional-body data generation device as set forth in claim 5, wherein the three-dimensional-body data generation device is configured for:
using, as the plurality of images, a plurality of images photographed in a state where the color sample is placed around each of a plurality of the target objects,
in the shape data generation process, a plurality of the three-dimensional shape data indicating a shape of the plurality of respective target objects being generated based on the plurality of images, and
in the color data generation process, a plurality of the color data indicating a color of the plurality of respective target objects being generated based on a color of the plurality of images after correction is performed in the color correction process.
